(19) United States
(12) Patent Application Publication
(10) Pub. No.: US 2007/0279737 A1
(43) Pub. Date: Dec. 6, 2007

(54) 3- DIMENSIONAL (3D) DISPLAY APPARATUS

(76) Inventor: Kyoung Su Ha, Uiwang-city (KR)

Correspondence Address: ST. ONGE STEWARD JOHNSTON & REENS, LLC, 986 BEDFORD STREET, STAMFORD, CT, 06905-5619, US

(21) Appl. No.: 11/686,124

(22) Filed: Mar. 14, 2007

(30) Foreign Application Priority Data
Jun. 2, 2006 (KR) 10-2006-0050090

(51) Int. Cl. G02B 27/22

(52) U.S. Cl. 359/462

(57) ABSTRACT

Provided is a 3-dimensional (3D) display apparatus which can prevent moirés or spots from being generated and achieve high-quality 3D images. The 3D display apparatus includes: a display panel; a filter disposed in front of the display panel; and a plurality of spacers disposed between the display panel and the filter, to maintain a constant gap between the display panel and the filter.

### CROSS-REFERENCE TO RELATED APPLICATIONS

The present application claims priority of Korean Patent Application No. 10-2006-0050090, filed on Jun. 2, 2006, the content of which is incorporated herein by reference.

### FIELD OF THE INVENTION

The present invention relates to a 3-Dimensional (3D) display apparatus, and more particularly, to a 3D display apparatus which can prevent moirés or spots from being generated and implement high-quality 3D images.

### BACKGROUND OF THE INVENTION

A conventional 3-dimensional (3D) display apparatus includes a display panel, and a filter which is attached to the surface of the display panel. Here, the filter may be a polarization plate or a phase retardation plate.

The display panel displays a left-eye image and a right-eye image alternately or concurrently. A user wears glasses including a filter having a predetermined correlation with the filter attached to the display panel, and views a 3D image in a manner to view only the left-eye image through his or her left eye and only the right-eye image through his or her right eye.

In order to implement the 3D display apparatus, it is essential to attach the filter to the display panel. However, in the case of the conventional 3D display apparatus, when the filter is attached to the display panel, the gap between the display panel and the filter becomes non-uniform over the display surface of the display panel, which deteriorates the performance of the 3D display apparatus. That is, in the case of the conventional 3D display apparatus, since the gap of the display panel and the filter becomes non-uniform, or since one part of the filter contacts the display panel while the other part of the filter does not contact the display panel, a reflexibility difference or a transmissivity difference due to light interference may occur at the interface between the filter and the display panel, at the surface of the filter toward the display panel, or at the surface of the display panel toward the filter. As a result, displayed images have moirés or spots, so that picture-quality deteriorates. Also, since left-eye images are mixed with right-eye images, a correct 3D image cannot be implemented.

Also, in the case of the conventional 3D display apparatus, since scattering materials inflow between the display panel and the filter when the 3D display apparatus is manufactured, and thus light passing through the filter does not have a correct polarization state, high-quality 3D images cannot be displayed.

### SUMMARY OF THE INVENTION

The present invention provides a 3-dimensional (3D) display apparatus which can prevent moirés or spots from being generated and achieve high-quality 3D images.

According to an aspect of the present invention, there is provided a 3-dimensional (3D) display apparatus including: a display panel; a filter disposed in front of the display panel; and a plurality of spacers disposed between the display panel and the filter, to maintain a constant gap between the display panel and the filter.

The 3D display apparatus further includes a medium injected into the gap between the display panel and the filter, the gap formed by the plurality of spacers.

A refraction index of the medium is equal to a refraction index of a member having the final surface of the display panel, through which light passes.

A refraction index of the medium is 1.5±0.4.

The plurality of spacers are formed with the same material as a member having the final surface of the display panel, through which light passes.

The plurality of spacers are formed with a polymer or a glass material.

A refraction index of the plurality of spacers is equal to a refraction index of a member having the final surface of the display panel, through which light passes.

A refractive index of the plurality of spacers is 1.5±0.4.

The size of each spacer is 750 nm or more.

According to another aspect of the present invention, there is provided a 3-dimensional (3D) display apparatus including: a display panel; and a filter disposed in front of the display panel, wherein a plurality of protrusions are formed on at least one surface of the surface of the filter toward the display panel and the final surface of the display panel through which light passes, to maintain a constant gap between the display panel and the filter.

The 3D display apparatus further includes a plurality of spacers disposed between the display panel and the filter, to maintain the constant gap between the display panel and the filter.

The 3D display apparatus further includes a medium injected into the gap between the display panel and the filter, the gap formed by the plurality of spacers.

A refraction index of the medium is equal to a refraction index of a member having the final surface of the display panel, through which light passes.

A refraction index of the medium is 1.5±0.4.

The plurality of spacers are formed with the same material as a member having the final surface of the display panel, through which light passes.

The plurality of spacers are formed with a polymer or a glass material.

A refraction index of the plurality of spacers is equal to a refraction index of a member having the final surface of the display panel, through which light passes.

A refractive index of the plurality of spacers is 1.5±0.4.

The size of each spacer is 750 nm or more.

The 3D display apparatus further includes a medium injected into the gap between the display panel and the filter, the gap formed by the plurality of protrusions.

A refraction index of the medium is equal to a refraction index of a member having the final surface of the display panel, through which light passes.

A refraction index of the medium is 1.5±0.4.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view schematically showing a 3-dimensional (3D) display apparatus according to an embodiment of the present invention;

FIG. 2 is a cross-sectional view of a part of the 3D display apparatus illustrated in FIG. 1;

FIG. 3 is a cross-sectional view of a part of a 3D display apparatus, according to another embodiment of the present invention;

FIG. 4 is a cross-sectional view of a part of a 3D display apparatus, according to another embodiment of the present invention;

FIG. 5 is a cross-sectional view of a part of a 3D display apparatus, according to another embodiment of the present invention;

FIG. 6 is a cross-sectional view of a part of a 3D display apparatus, according to another embodiment of the present invention; and

FIG. 7 is a cross-sectional view of a part of a 3D display apparatus, according to another embodiment of the present invention.

### DETAILED DESCRIPTION OF THE INVENTION

Hereinafter, the present invention will be described in detail with reference to the appended drawings.

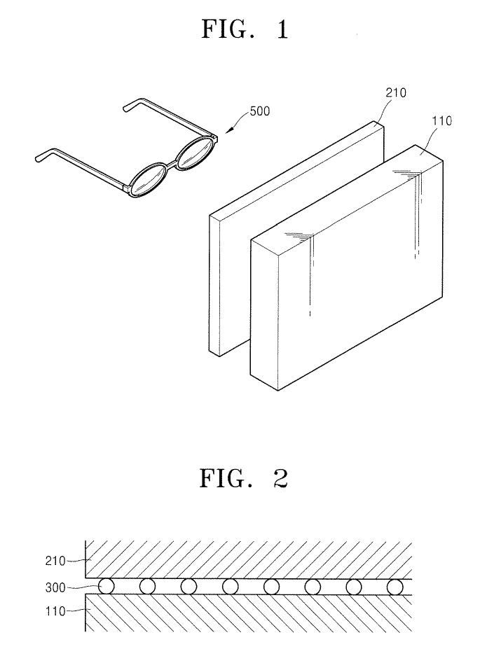

FIG. 1 is an exploded perspective view schematically showing a 3-dimensional (3D) display apparatus according to an embodiment of the present invention. Referring to FIG. 1, the 3D display apparatus according to the current embodiment includes a display panel 110 and a filter 210 which is disposed in front of the display panel 110. The filter 210 may be a polarization plate, a phase retardation plate, or a combination of a polarization plate and a phase retardation plate. Also, the filter 210 may be an active filter or a passive filter.

The display panel 110 can display a left-eye image and a right-eye image alternately. Glasses 500 which a viewer wears may be shuttering glasses which are synchronized with the display panel 110. That is, the glasses 500 block the viewer's right eye so that only the viewer's left eye can view the displayed image when the display panel 110 displays a left-eye image, and block the viewer's left-eye so that only the viewer's right-eye can view the displayed image when the display panel 110 displays a right-eye image. Also, the left-eye lens and right-eye lens of the glasses 500 may be lenses through which light having different polarization states passes respectively. In this case, the filter 210 may be an active filter so that the filter 210 can cause an image displayed by the display panel 110 to be in the specific polarization states, alternately for the left-eye and right-eye lenses.

On the contrary, the display panel 110 can display a left-eye image and a right-eye image, alternately for each line. In this case, the left-eye lens and right-eye lens of the glasses 500 are lenses through which light having different polarization states passes respectively, and the filter 210 is a passive filter, wherein one part through which left-eye images pass and the other part through which right-eye images pass can cause light passing therethrough to be in different polarization states, respectively. Or, the display panel 110 is divided into two regions (that is, a left-eye image region and a right-eye image region) in which a left-eye image and a right-eye image are respectively displayed, and the filter 210 is divided into regions corresponding respectively to the left-eye region and right-eye region of the display panel 110, and assigns different polarization states respectively to the left-eye image and the right-eye image. In this case, the left-eye and right-eye image regions of the display panel 110 can vary with the passage of time, and accordingly, the left-eye and right-eye image regions of the filter 210 also can vary with the passage of time.

Also, the 3D display apparatus can display 3D images using a variety of different methods. The 3D display apparatus allows a viewer to view 3D images, by allowing him or her to view only left-eye images through his or her left eye and view only right-eye images through his or her right eye by interaction of the glasses 500 and the filter 210. However, the 3D display apparatus can use a glassless-type method, such as a Lenticular method, in which no glasses are used.

FIG. 2 is a cross-sectional view of a part of the 3D display apparatus illustrated in FIG. 1. Referring to FIG. 2, spacers 300 are disposed between the display panel 110 and the filter 210. The spacers 300 act to maintain a constant gap between the display panel 110 and the filter 210.

As described above, if the gap between the display panel 110 and the filter 210 becomes non-uniform, or if one part of the filter 210 contacts the display panel 110 while the other part of the filter 210 does not contact the display panel 110, a reflexibility difference or a transmissivity difference due to light interference may occur at the interface between the filter 210 and the display panel 110, at the surface of the filter 210 toward the display panel 110, or at the surface of the display panel toward the filter. As a result, displayed images have moirés or spots, so that picture-quality deteriorates. Also, since left-eye images are mixed with right-eye images, a correct 3D image cannot be implemented.

However, in the 3D display apparatus according to the current embodiment, since spacers 300 are disposed between the display panel 110 and the filter 210 to maintain a constant gap between the display panel 110 and the filter 210, it is possible to significantly enhance the picture-quality of displayed images. Also, the spacers 300 seal up the space between the display panel 110 and the filter 210, thus preventing scattering materials from inflowing between the display panel 110 and the filter 210.

The spacers 300 can have a transparent fine globular shape, and be made of an inorganic material, such as glass and silica, or a polymer material such as polystyrene, etc. Also, a refractive index of the spacers 300 is preferably similar to a refractive index of a member having the final surface of the display panel 110, through which light passes. This is aimed to prevent light emitted through the display panel 110 from being refracted or reflected in the interface between the display panel 110 and the spacers 300.

Since the member having the final surface of the display panel 110, through which light passes, is generally a glass substrate, the refractive index of the spacers 300 can be about 1.5±0.4, similar to the refractive index of glass. The number of spacers 300 corresponding to a pixel may be from 5 to 50.

Meanwhile, in order to implement a 3D image, the wavelength of light emitted from the display panel 110 is about 750 nm or less. Accordingly, it is preferable that the diameter of each spacer 300 is 750 nm or more so that the gap between the display panel 110 and the filter 210, which is maintained by the spacers 300, is 750 nm or more. This is because a probability that light emitted from the display panel 110 causes destructive interference or constructive interference between the display panel 110 and the filter 210 increases and accordingly moirés can be formed on displayed images, if the gap between the display panel 110 and the filter 210 which is maintained by the spacers 300 is 750 nm or less. If the gap between the display panel 110 and the filter 210 which is maintained by the spacers 300 is 750 nm or more, since a probability that light emitted from the display panel 110 causes destructive interference or constructive interference between the display panel 110 and the filter 210 is optically reduced significantly, high-quality 3D images can be implemented.

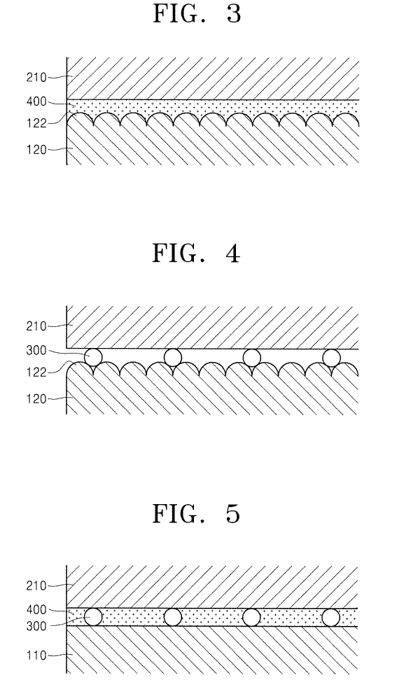

FIG. 3 is a cross-sectional view of a part of a 3D display apparatus, according to another embodiment of the present invention. Referring to FIG. 3, a liquid- or gel-type medium 400 is injected between a filter 210 and a display panel 120 subjected to antiglare processing. The display panel 120 subjected to antiglare processing is a display panel 120 on which a plurality of protrusions 122 are formed, as illustrated in FIG. 3. The plurality of protrusions 122 can be formed with a variety of shapes, for example, with a round shape as illustrated in FIG. 3.

The protrusions 122 formed in the surface of the display panel 120 subjected to antiglare processing can form a gap between the display panel 120 and the filter 210, and also scatter light which passes therethrough. Accordingly, by injecting the medium 400 between the display panel 120 and the filter 210, such light scattering is prevented, so that images with high picture-quality can be displayed. The medium 400 may be a transparent liquid such as glycerin. A refractive index of the medium 400 is preferably similar to a refractive index of a member having the final surface of the display panel 120, through which light passes. This is aimed to prevent light emitted through the display panel 110 from being refracted or reflected in the interface between the display panel 110 and the spacers 300.

Since the member having the final surface of the display panel 110, through which light passes, is generally a glass substrate, the refractive index of the medium 400 can be about 1.5±0.4, similar to the refractive index of glass. The medium is injected at a constant pressure between the display panel 120 and the filter 30 so that the medium 400 does not cluster on a specific part. A process of injecting the medium 400 between the display panel 120 and the filter 210 can be performed in the same way as a process of injecting a liquid crystal between two opposite substrates when a liquid display panel is manufactured. A barrier (not shown) can be formed along the edges of the display panel 120 in order to prevent the medium 400 injected between the display panel 120 and the filter 210 from leaking to the outside. Also, by increasing the viscosity of the medium 400, it is possible to prevent the medium 400 from leaking to the outside. However, the present invention is not limited to these, and a variety of modifications are possible.

Also, differently from the embodiment illustrated in FIG. 3, no medium can be injected between the display panel 120 and the filter 210. In this case, the protrusions 122 of the display panel 120 function as the spacers 300 described in the embodiment of FIG. 2.

FIG. 4 is a cross-sectional view of a part of a 3D display apparatus, according to another embodiment of the present invention.

Referring to FIG. 4, spacers 300 are disposed between a filter 210 and a display panel 120 subjected to antiglare processing, so that a gap between the display panel 120 and the filter 210 is kept more uniform. Also, since the spacers 300 seal up the gap between the display panel 120 and the filter 210, it is possible to prevent a scattering material from inflowing between the display panel 120 and the filter 210. Also, the spacers 300 can prevent moirés or spots from being generated due to a contact between the display panel 110 and the filter 210.

The spacers 300 can be made of the same material as described above with reference to FIG. 2, and have the same size as described above with reference to FIG. 2. If each spacer 300 is a globular shape, as illustrated in FIG. 4, the spacer 300 can be disposed between the protrusions 122 of the display panel 120.

FIG. 5 is a cross-sectional view of a part of a 3D display apparatus, according to another embodiment of the present invention.

Referring to FIG. 5, spacers 300 are disposed between the display panel 110 and the filter 210, and a medium 400 is injected into the gap between the display panel 110 and the filter 210, which is formed by the spacers 300. Since the spacers 300 maintains a constant gap between the display panel 110 and the filter 210, the spacers 300 prevent moirés or spots from being generated due to gap non-uniformity between the display panel 110 and the filter 210. The medium 400 prevents light from scattering due to the spacers 300, and seals up the gap between the display panel 110 and the filter 210, thereby preventing impurities, etc. from inflowing between the display panel 110 and the filter 210. The spacers 300 can be made of the same material as described above with reference to FIG. 2, and have the same size as described above with reference to FIG. 2. Also, the medium 400 can be made of the same material as described above with reference to FIG. 3.

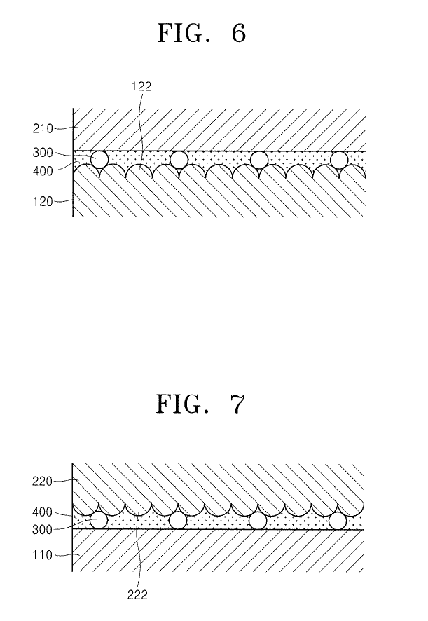

FIG. 6 is a cross-sectional view of a part of a 3D display apparatus, according to another embodiment of the present invention. Referring to FIG. 6, spacers 300 are disposed between a filter 210 and a display panel 120 subjected to antiglare processing, thereby maintaining a constant gap between the display panel 120 and the filter 210. Also, a medium 400 is injected into the gap between the display panel 120 and the filter 210, which is formed by the spacers 300. The spacers 300 maintain a constant gap between the display panel 120 and the filter 210, thereby preventing moirés or spots from being generated due to a contact between the filter 210 and protrusions 122 of the display panel 110 subjected to antiglare processing. The medium 400 prevents light from scattering due to the spacers 300, and seals up the gap between the display panel 110 and the filter 210, thereby preventing impurities, etc. from inflowing between the display panel 110 and the filter 210. The spacers 300 can be made of the same material as described above with reference to FIG. 2, and have the same size as described above with reference to FIG. 2. The medium 400 may be made of the same material as described above with reference to FIG. 3.

FIG. 7 is a cross-sectional view of a part of a 3D display apparatus, according to another embodiment of the present invention. Referring to FIG. 7, the 3D display apparatus according to the current embodiment includes a display panel 110 and a filter 220 subjected to antiglare processing. The filter 220 subjected to antiglare processing has a structure on which a plurality of protrusions 222 are formed toward the display panel 110. Spacers 300 are disposed between the display panel 110 and the filter 220, thereby maintaining a constant gap between the display panel 110 and the filter 220. Also, a medium 400 is injected into the gap between the display panel 110 and the filter 220, which is formed by the spacers 300. Since the spacers 300 maintain a constant gap between the display panel 110 and the filter 220, it is possible to prevent moirés or spots from being generated due to a contact between the display panel 110 and the filter 220 subjected to antiglare processing. The medium 400 prevents light from scattering due to the spacers 300, and seals up the gap between the display panel 110 and the filter 220, thereby preventing impurities, etc. from inflowing between the display panel 110 and the filter 220. The spacers 300 can be made of the same material as described above with reference to FIG. 2, and have the same size as described above with reference to FIG. 2. Also, the medium 400 can be made of the same material as described above with reference to FIG. 3.

Also, a 3D display apparatus can be implemented by combining the above-described embodiments with each other. For example, both a display panel and a filter can be subjected to antiglare processing, and at least one of a medium and spacers can be disposed between the display panel and the filter. However, the present invention is not limited to these, and a variety of modifications are possible.

As described above, in a 3D display apparatus according to the present invention, by maintaining a constant gap between a display panel and a filter, it is possible to effectively prevent moirés or spots from being generated.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A 3-dimensional (3D) display apparatus comprising:
a display panel;
a filter disposed in front of the display panel; and
a plurality of spacers disposed between the display panel and the filter, to maintain a constant gap between the display panel and the filter.

2. The 3D display apparatus of claim 1, further comprising a medium injected into the gap between the display panel and the filter, the gap formed by the plurality of spacers.

3. The 3D display apparatus of claim 2, wherein a refraction index of the medium is equal to a refraction index of a member having the final surface of the display panel, through which light passes.

4. The 3D display apparatus of claim 2, wherein a refraction index of the medium is 1.5±0.4.

5. The 3D display apparatus of claim 1, wherein the plurality of spacers are formed with the same material as a member having the final surface of the display panel, through which light passes.

6. The 3D display apparatus of claim 1, wherein the plurality of spacers are formed with a polymer or a glass material.

7. The 3D display apparatus of claim 1, wherein a refraction index of the plurality of spacers is equal to a refraction index of a member having the final surface of the display panel, through which light passes.

8. The 3D display apparatus of claim 1, wherein a refractive index of the plurality of spacers is 1.5±0.4.

9. The 3D display apparatus of claim 1, wherein the size of each spacer is 750 nm or more.

10. A 3-dimensional (3D) display apparatus comprising:
a display panel; and
a filter disposed in front of the display panel,
wherein a plurality of protrusions are formed on at least one surface of the surface of the filter toward the display panel and the final surface of the display panel through which light passes, to maintain a constant gap between the display panel and the filter.

11. The 3D display apparatus of claim 10, further comprising a plurality of spacers disposed between the display panel and the filter, to maintain the constant gap between the display panel and the filter.

12. The 3D display apparatus of claim 11, further comprising a medium injected into the gap between the display panel and the filter, the gap formed by the plurality of spacers.

13. The 3D display apparatus of claim 12, wherein a refraction index of the medium is equal to a refraction index of a member having the final surface of the display panel, through which light passes.

14. The 3D display apparatus of claim 12, wherein a refraction index of the medium is 1.5±0.4.

15. The 3D display apparatus of claim 11, wherein the plurality of spacers are formed with the same material as a member having the final surface of the display panel, through which light passes.

16. The 3D display apparatus of claim 11, wherein the plurality of spacers are formed with a polymer or a glass material.

17. The 3D display apparatus of claim 11, wherein a refraction index of the plurality of spacers is equal to a refraction index of a member having the final surface of the display panel, through which light passes.

18. The 3D display apparatus of claim 11, wherein a refractive index of the plurality of spacers is 1.5±0.4.

19. The 3D display apparatus of claim 11, wherein the size of each spacer is 750 nm or more.

20. The 3D display apparatus of claim 10, further comprising a medium injected into the gap between the display panel and the filter, the gap formed by the plurality of protrusions.

21. The 3D display apparatus of claim 20, wherein a refraction index of the medium is equal to a refraction index of a member having the final surface of the display panel, through which light passes.

22. The 3D display apparatus of claim 20, wherein a refraction index of the medium is 1.5±0.4.
